(19) United States
(12) Patent Application Publication
(10) Pub. No.: US 2020/0247100 A1
(43) Pub. Date: Aug. 6, 2020

(54) WINDOW FILM

(71) Applicant: 3M INNOVATIVE PROPERTIES COMPANY, St. Paul, MN (US)

(72) Inventor: Takashi Yamasaki, Yamagata (JP)

(21) Appl. No.: 16/652,169

(22) PCT Filed: Oct. 3, 2018
(86) PCT No.: PCT/IB2018/057684

§ 371 Date: Mar. 30, 2020

(30) Foreign Application Priority Data
Oct. 3, 2017 (JP) 2017-196049

(51) Int. Cl. B32B 27/36; B32B 7/12; B32B 27/08

(52) U.S. Cl. CPC B32B 27/36; B32B 7/12; B32B 27/08; B32B 2255/10; B32B 2419/00; B32B 2255/26; B32B 2255/28; B32B 2307/30; B32B 2307/728; B32B 2255/20

(57) ABSTRACT

Provided is a window film that is affixed to a window surface, is easily installed, and is capable of facilitating the vaporization of generated condensation to accelerate drying of the window surface. The window film having: a hydrophilic outermost surface; and a heat-generating layer which contains a near infrared ray absorbing material, absorbs near infrared rays, and generates heat.

### TECHNICAL FIELD

The present invention relates to a window film.

### BACKGROUND ART

Conventionally, various methods for preventing condensation on window surfaces have been examined. For example, Patent Document 1 discloses a method for attaching a resin panel, through a spacer having a prescribed thickness, to an interior side and/or an exterior side of a plate glass of a glass window and forming a heat insulating air layer between the plate glass and the resin panel.

In addition, Patent Document 2 discloses a method for preventing the generation of condensation by heating a window glass surface using a heater for preventing condensation, and maintaining the temperature so that the air contacting the window glass does not reach the dew point.

### CITATION LIST

### Patent Literature

Patent Document 1: JP 2011-252328 A

Patent Document 2: JP 2003-106677 A

### SUMMARY OF INVENTION

However, with conventional condensation prevention methods, schemes must be used on the structure of the entire window section, and a large apparatus such as a heater for preventing condensation is required, and therefore problems with these conventional methods include the difficulty of applying these methods to existing window sections, and the large amount of labor and expenses that are required for application.

Therefore, an object of the present invention is to provide a window film that is affixed to a window surface, is easily installed, and is capable of facilitating the vaporization of generated condensation to accelerate drying of the window surface.

One aspect of the present invention relates to a window film having: a hydrophilic outermost surface; and a heat-generating layer which contains a near infrared ray absorbing material, absorbs near infrared rays, and generates heat.

The abovementioned window film easily enables a countermeasure to condensation by affixing the film to a window surface. The outermost surface of the window film is hydrophilic, and therefore condensation that is produced is easily wet spread over the outermost surface. Furthermore, the heat-generating layer of the window film absorbs near infrared rays in sunlight from the window surface and generates heat. Condensation that has been wet spread on the outermost surface is heated by the heat that is generated by the heat-generating layer, and vaporization is thereby facilitated. Therefore, the vaporization of generated condensation can be facilitated and drying of the window surface can be accelerated by affixing the window film to the window surface.

The present invention provides a window film that is affixed to a window surface, is easily installed, and is capable of facilitating the vaporization of generated condensation to accelerate drying of the window surface.

### BRIEF DESCRIPTION OF DRAWINGS

FIG. 1 is a cross-sectional view illustrating a first embodiment of the window film.

FIG. 2 is a cross-sectional view illustrating a second embodiment of the window film.

FIG. 3 is a cross-sectional view illustrating a third embodiment of the window film.

FIG. 4 is a cross-sectional view illustrating a fourth embodiment of the window film.

FIG. 5 is a cross-sectional view illustrating a fifth embodiment of the window film.

FIG. 6 is a cross-sectional view illustrating a sixth embodiment of the window film.

### DETAILED DESCRIPTION

Preferred embodiments of the present invention are described below with reference to the drawings. Note that identical elements have been assigned identical reference signs in the explanation of the drawings, and duplicate explanations are omitted. Furthermore, the drawings illustrate portions embellished in order to facilitate understanding, and the dimensional ratios and the like are not limited to those illustrated in the drawings. Note that in the present specification, a “window film” indicates a film that is affixed to the entire surface of a window or to a portion thereof for use. The window on which the window film can be applied is not limited, and may be a window of a structure such as a home or building, and may be a window of a moving body such as a bus, vehicle, or boat.

The window film according to the present embodiment has: a hydrophilic outermost surface; and a heat-generating layer which contains a near infrared ray absorbing material.

The window film according to the present embodiment is affixed to a window surface so that a surface of a side that is opposite the outermost surface becomes the window surface side. The heat-generating layer absorbs near infrared rays and generates heat, and the vaporization of condensation that is generated on the outermost surface is facilitated by the heat generated by the heat-generating layer. The outermost surface is hydrophilic, and therefore condensation that is generated on the outermost surface is easily wet spread. Therefore, the vaporization facilitation effect from the heat-generating layer can be remarkably obtained in comparison to a case in which condensation is adhered in the shape of water droplets.

The window film according to the present embodiment may be a film which transmits at least a portion of visible light. This type of window film enables visibility of the environment outside the window through the window film, and therefore is easily applied to a window that requires visibility. The visible light transmittance of the window film may be, for example, 20% or greater, preferably 40%, and more preferably 60% or greater. Note that in the present embodiment, the outermost surface of the window film is hydrophilic, and therefore when condensation is produced, the condensation does not easily form into water droplet shapes, and is easily wet spread over the outermost surface. Therefore, in comparison to a case in which condensation is adhered in the shape of water droplets, visibility of the environment outside the window is improved, and even if condensation occurs, sufficient visibility can be maintained.

In the present embodiment, the angle of contact with water on the outermost surface is preferably 20° or less. With this type of hydrophilic outermost surface, condensation more easily wet spreads, the vaporization facilitation effect is more remarkably obtained, and visibility is also more favorable. The angle of contact with water on the outermost surface is more preferably 15° or less, and even more preferably 10° or less. The lower limit of the angle of contact with water on the outermost surface is not particularly limited.

Note that in the present specification, the angle of contact with water indicates a value that is measured in accordance with the sessile drop method set forth by JIS R 3257:1999.

In the present embodiment, the method for imparting hydrophilicity to the outermost surface is not particularly limited. For example, the outermost surface may be configured by a surface layer containing a hydrophilic functional group, or may be configured by a surface layer that has been subjected to a hydrophilic treatment.

The outermost surface preferably has a hydrophilic functional group. In the present embodiment, the hydrophilic material configuring the outermost surface may have a hydrophilic functional group, or a hydrophilic functional group may be formed on the outermost surface through a hydrophilic treatment. Examples of the hydrophilic functional group include a hydroxy group, a carboxyl group, and an ionic functional group.

Examples of the hydrophilic material include polyvinyl alcohol, polysilazane, polyhydroxyethyl methacrylate, and other such polymer materials; magnesium fluoride hydroxide, and other such inorganic materials.

Examples of the hydrophilic treatment include a corona treatment, a plasma treatment, a flame treatment, an ultraviolet irradiation treatment, and other such surface modification treatment methods. In addition, examples of the hydrophilic treatment include a method of disposing a photocatalyst on the outermost surface, and using the action of the photocatalyst to cause photoexcitation hydrophilization.

The heat-generating layer is a layer that absorbs near infrared rays and generates heat, and contains a near infrared ray absorbing material. The heat-generating layer preferably has an absorption rate of 30% or higher in a near infrared range of wavelengths from 780 nm to 2500 nm. This type of heat-generating layer easily generates heat through sunlight from the window surface, and therefore a condensation vaporization facilitation effect is more remarkably exhibited. The absorption rate in the abovementioned near infrared range is more preferably 40% or higher, and is even more preferably 50% or higher.

The absorption rate in the near infrared range of wavelengths from 780 nm to 2500 nm of the window film according to the present embodiment is preferably 30% or higher, more preferably 40% or higher, and even more preferably 50% or higher. In the present embodiment, the absorption of near infrared rays and the generation of heat may occur at a layer besides the heat-generating layer, and the condensation vaporization facilitation effect is more remarkably exhibited by having the abovementioned absorption rate as an entire window film.

The near infrared ray absorbing material is not particularly limited. Examples of the near infrared ray absorbing material include metal oxides, organic dyes, and organometallic complexes, and of these, metal oxides, and particularly metal oxides such as indium tin oxide (ITO) and antimony-doped tin oxide (ATO) can be suitably used.

The content amount of the near infrared ray absorbing material in the heat-generating layer is not particularly limited, and for example, is adjusted, as appropriate, within a range at which the abovementioned favorable absorption rate can be obtained.

The heat-generating layer need only be a layer that absorbs near infrared rays and generates heat, but the heat-generating layer may further have other functions. For example, the heat-generating layer may be hydrophilic on one side, and this side may configure the abovementioned outermost surface. In addition, the heat-generating layer may further contain an adhesive, and may configure an adhesion surface that allows adhesion with the window surface. The heat-generating layer may also have a function as a substrate allowing the strength of the window film. That is, the heat-generating layer may be, for example, a layer for which a near infrared ray absorbing material is blended with an adhesive layer containing an adhesive, and may be a layer for which a near infrared ray absorbing material is blended in a substrate film.

The window film according to the present embodiment may have, at a surface of a side opposite the outermost surface, an adhesion surface for adhering to the window surface. According to this type of window film, a countermeasure to condensation can be easily implemented on the window surface by adhering the adhesion surface with the window surface.

The adhesion surface may be configured, for example, by an adhesive layer containing an adhesive. The type of adhesive is not particularly limited, and may be any adhesive as long as the window film can be adhered to the window surface. Specific examples of the adhesive include acrylic resins, urethane resins, and silicone resins, and of these, acrylic resins are particularly suitably used. The adhesive is preferably a pressure-sensitive adhesive layer, and the adhesive layer is preferably a pressure-sensitive adhesive layer containing a pressure-sensitive adhesive.

The window film according to the present embodiment favorably has a substrate film from the perspective of facilitating the work of affixing the window film to a window surface. The substrate film is not particularly limited as long as it is a film that can impart to the window film the strength necessary for the operation of affixing the window film to a window surface. The material constituting the substrate film is not particularly limited, and for example, can be a polyester film, a polycarbonate film, a polyvinyl chloride film, and a polyacrylic film.

The thickness of the substrate film is not particularly limited as long as it is a thickness that allows the window film to maintain sufficient strength. For example, the thickness of the substrate film may be 15 μm or greater, or 25 μm or greater, and 1 mm or less, or 100 μm or less.

Preferred embodiments of the window film are described below with reference to the drawings.

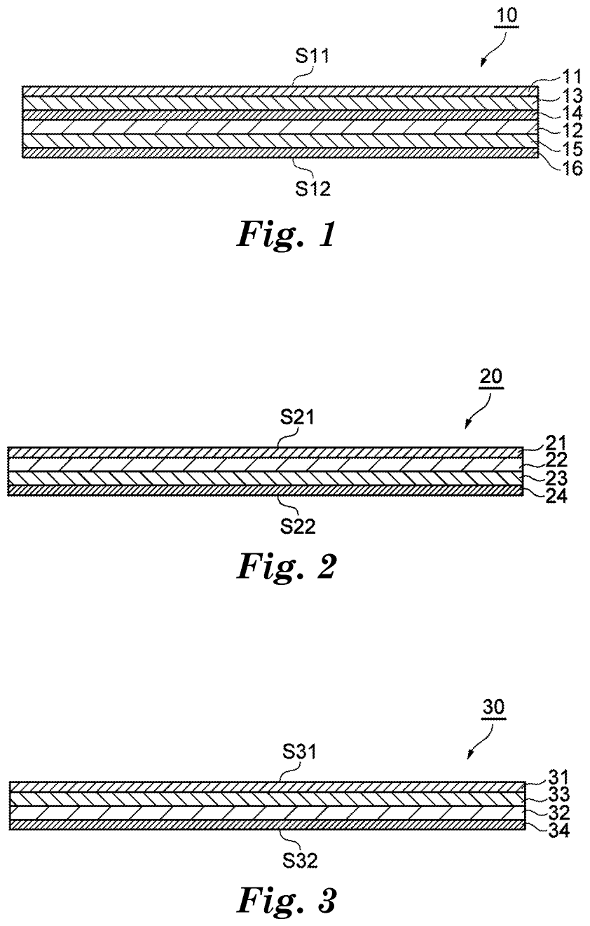

FIG. 1 is a cross-sectional view illustrating a first embodiment of the window film. A window film 10 includes a surface layer 11, a first substrate film 13, a first adhesive layer 14, a heat-generating layer 12, a second substrate film 15, and a second adhesive layer 16, and each layer is laminated in this order. In the window film 10, the surface layer 11 has a hydrophilic outermost surface S11, and the second adhesive layer 16 has an adhesion surface S12. The window film 10 is affixed to a window surface through the adhesion surface S12 of the second adhesive layer 16.

The window film 10 can also be configured by combining a hydrophilic film having the surface layer 11 provided on one side of the first substrate film 13 and having the first adhesive layer 14 provided on the other side, with a near infrared ray absorbing film having the heat-generating layer 12 provided on one side of the second substrate film 15 and having the second adhesive layer 16 provided on the other side.

In the window film 10, the surface layer 11 is retained by the first substrate film 13, and the heat-generating layer 12 is retained by the second substrate film 15, and therefore even if the strengths of each of the surface layer 11 and the heat-generating layer 12 are low, the strength of the overall film can be easily maintained.

In the window film 10, near infrared rays from the window surface are absorbed by the heat-generating layer 12, and thereby the heat-generating layer 12 generates heat, and vaporization of condensation on the outermost surface S11 is facilitated.

FIG. 2 is a cross-sectional view illustrating a second embodiment of the window film.

A window film 20 includes a surface layer 21, a heat-generating layer 22, a substrate film 23, and an adhesive layer 24, and each layer is laminated in this order. In the window film 20, the surface layer 21 has a hydrophilic outermost surface S21, and the adhesive layer 24 has an adhesion surface S22. The window film 20 is affixed to a window surface through the adhesion surface S22 of the adhesive layer 24.

The window film 20 can also be configured by forming the surface layer 21 on the heat-generating layer 22 of a near infrared ray absorbing film provided with the heat-generating layer 22 on one side of the substrate film 23 and the adhesive layer 24 on the other side.

In the window film 20, near infrared rays from the window surface are absorbed by the heat-generating layer 22, and thereby the heat-generating layer 22 generates heat, and vaporization of condensation on the outermost surface S21 is facilitated.

FIG. 3 is a cross-sectional view illustrating a third embodiment of the window film. A window film 30 includes a surface layer 31, a substrate film 33, a heat-generating layer 32, and an adhesive layer 34, and each layer is laminated in this order. In the window film 30, the surface layer 31 has a hydrophilic outermost surface S31, and the adhesive layer 34 has an adhesion surface S32. The window film 30 is affixed to a window surface through the adhesion surface S32 of the adhesive layer 34.

The window film 30 can also be configured by forming the adhesive layer 34 on the heat-generating layer 32 of a composite film provided with the surface layer 31 on one side of the substrate film and the heat-generating layer 32 on the other side.

in the window film 30, near infrared rays from the window surface are absorbed by the heat-generating layer 32, and thereby the heat-generating layer 32 generates heat, and vaporization of condensation on the outermost surface S31 is facilitated.

With the window film 30, the surface layer 31 and the heat-generating layer 32 are retained by the substrate film 33, and therefore even if the strength of each of the surface layer 31 and the heat-generating layer 32 is low, the strength of the overall film can be easily maintained.

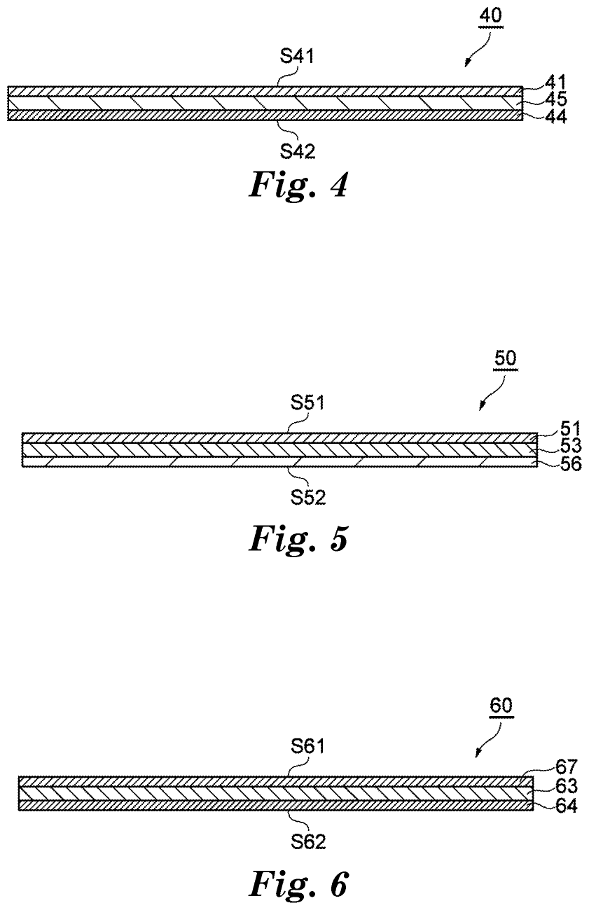

FIG. 4 is a cross-sectional view illustrating a fourth embodiment of the window film. A window film 40 includes a surface layer 41, a heat-generating layer 45 containing a near infrared ray absorbing material, and an adhesive layer 44, and each layer is laminated in this order. In the window film 40, the surface layer 41 has a hydrophilic outermost surface S41, and the adhesive layer 44 has an adhesion surface S42. The window film 40 is affixed to a window surface through the adhesion surface S42 of the adhesive layer 44. With the window film 40, the heat-generating layer 45 also functions as a substrate film.

The window film 40 can be configured by forming the surface layer 41 on one side of the heat-generating layer 45, in which a near infrared ray absorbing material is blended, and the adhesive layer 44 on the other side thereof.

In the window film 40, near infrared rays from the window surface are absorbed by the heat-generating layer 45, and thereby the heat-generating layer 45 generates heat, and vaporization of condensation on the outermost surface S41 is facilitated.

In the window film 40, the heat-generating layer 45 functions as a substrate for guaranteeing the strength of the overall film, and functions as a heat-generating layer for generating heat through near infrared rays, and therefore the layer structure can be simplified, and the thickness of the window film 40 can be made thinner in comparison to other embodiments.

Furthermore, in the window film 40, the surface layer 41 and the adhesive layer 44 are retained by the heat-generating layer 45, and therefore even if the strengths of each of the surface layer 41 and the adhesive layer 44 are low, the strength of the overall film can be easily maintained.

FIG. 5 is a cross-sectional view illustrating a fifth embodiment of the window film. A window film 50 includes a surface layer 51, a substrate film 53, and a heat-generating layer 56 having tacky adhesiveness and containing a near infrared ray absorbing material, and each layer is laminated in this order. In the window film 50, the surface layer 51 has a hydrophilic outermost surface S51, and the heat-generating layer 56 has an adhesion surface S52. The window film 50 is affixed to a window surface through the adhesion surface S52 of the heat-generating layer 56. With the window film 50, the heat-generating layer 56 contains a near infrared ray absorbing material, and also has tacky adhesiveness and functions as an adhesive layer.

The window film 50 can be configured by forming the surface layer 51 on one side of the substrate film 53, and the heat-generating layer 56, which contains a tacky adhesive component and a near infrared ray absorbing material, on the other side thereof.

In the window film 50, near infrared rays from the window surface are absorbed by the heat-generating layer 56, and thereby the heat-generating layer 56 generates heat, and vaporization of condensation on the outermost surface S51 is facilitated.

In the window film 50, the heat-generating layer 56 has a function of adhering the window surface and the window film 50, and a function as a heat-generating layer to generate heat through near infrared rays, and therefore the layer structure can be simplified, and the thickness of the window film 50 can be made thinner in comparison to other embodiments.

In addition, in the window film 50, the surface layer 51 and the heat-generating layer 56 are retained by the substrate film 53, and therefore even if the strength of each of the surface layer 51 and the heat-generating layer 56 is low, the strength of the overall film can be easily maintained.

FIG. 6 is a cross-sectional view illustrating a sixth embodiment of the window film. A window film 60 includes a heat-generating layer 67 containing a near infrared ray absorbing material, a substrate film 63, and an adhesive layer 64, and each layer is laminated in this order. In the window film 60, the heat-generating layer 67 has a hydrophilic outermost surface S61, and the adhesive layer 64 has an adhesion surface S62. The window film 60 is affixed to a window surface through the adhesion surface S62 of the adhesive layer 64.

The heat-generating layer 67 has a hydrophilic outermost surface S61. This outermost surface S61 is, for example, formed by subjecting the heat-generating layer 67 that contains a near infrared ray absorbing material to a hydrophilic treatment, and may be formed by configuring the heat-generating layer 67 with a hydrophilic material that contains a near infrared ray absorbing material and a hydrophilic polymer.

The window film 60 can be configured so that the heat-generating layer 67 having a hydrophilic outermost surface S61 is formed on one side of the substrate film 63, and the adhesive layer 64 is formed on the other side thereof.

In the window film 60, near infrared rays from the window surface are absorbed by the heat-generating layer 67, and thereby the heat-generating layer 67 generates heat, and vaporization of condensation on the outermost surface S61 is facilitated.

In the window film 60, the heat-generating layer 67 functions as a surface layer that provides a hydrophilic outermost surface, and functions as a heat-generating layer for generating heat through near infrared rays, and therefore the layer structure can be simplified, and the thickness of the window film 60 can be made thinner in comparison to other embodiments.

Furthermore, in the window film 60, the heat-generating layer 67 and the adhesive layer 64 are retained by the substrate film 63, and therefore even if the strength of each of the heat-generating layer 67 and the adhesive layer 64 is low, the strength of the overall film can be easily maintained.

Although above descriptions were given for the preferred embodiments of the present invention, the present invention is not limited to the aforementioned embodiments.

### EXAMPLES

The present invention will be described more specifically below using examples, but the present invention is not intended to be limited to the examples.

### Example 1

A window film having the configuration of the window film 10 illustrated in FIG. 1 was fabricated. More specifically, a laminated film (HF001, from Reiko Co., Ltd.) having a hydrophilic coating layer formed on a 50 μm thick PET film was used as the first substrate film 13 and the surface layer 11, and a 20 μm thick acrylic resin pressure-sensitive adhesive (PMJ-1435, from 3M) was used as the first adhesive layer 14. In addition, a film was formed with a dried thickness of 2 μm through a gravure coating method using a mixed solution obtained by mixing an ITO paint (PI-3Y, from Mitsubishi Materials Electronic Chemicals Co., Ltd.) and a carbon black dispersion (MHI Black #A980M, from Mikuni Color Ltd.) at a weight ratio of 100:2, the film was then cured through ultraviolet irradiation with a cumulative irradiation dose of 108 mJ/cm² to form a layer, and this layer was used as the heat-generating layer 12. In addition, a 50 μm thick polyester film (CM875, from 3M) was used as the second substrate film 15, and a 24 μm thick acrylic resin pressure-sensitive adhesive (PMJ-1435, from 3M) was used as the second adhesive layer 16.

The angle of contact with water on the outermost surface, the near infrared ray absorption rate of the window film, and the visible light transmittance of the window film were determined by following methods for the fabricated window film. The results are shown in Table 1.

<Measurement of the Angle of Contact with Water>

The angle of contact with water was measured using a contact angle meter (DM-501, from Kyowa Interface Science Co., Ltd.) in accordance with the sessile drop method described in JIS R 3257:1999. More specifically, the contact angle of the window film surface with respect to distilled water was measured in a state in which the window film was affixed to a float glass measuring 50 mm ×50 mm with a thickness of 3 mm.

<Measurement of the Near Infrared Ray Absorption Rate>

The near infrared ray absorption rate of the window film was determined through the following method.

An ultraviolet-visible-near infrared spectrophotometer (U-4100, from Hitachi, Ltd.) was used to measure the spectral transmittance [τ(λ)] of various wavelengths from 780 to 2500 nm in accordance with the method for measuring sunlight transmittance described in JIS A 5759:2016, and the near infrared transmittance (τ) was determined through the equation (1), which multiplies the relative spectral distribution (E_{λ}) of sunlight in the corresponding wavelength range, and the weight value coefficient (E_{τ}Δλ) obtained from the wavelength spacing (Δλ) and obtains a weighted average.

$$\begin{matrix} [ Equation 1 ] & \\ τ = \frac{{\sum }_{780}^{2500} τ ( λ ) {E}_{λ} Δλ}{{\sum }_{780}^{2500} {E}_{λ} Δ λ} & ( 1 )\end{matrix}$$

Likewise, an ultraviolet-visible-near infrared spectrophotometer (U-4100, from Hitachi, Ltd.) was used to measure the spectral reflectance [ρ(λ)] of various wavelengths from 780 to 2500 nm in accordance with the method for measuring sunlight reflectance described in JIS A 5759:2016, and the near infrared reflectance (ρ) was determined through the equation (2), which multiplies the relative spectral distribution (E_{λ}) of sunlight in the corresponding wavelength range, and the weight value coefficient (E_{λ}Δλ) obtained from the wavelength spacing (Δλ) and obtains a weighted average.

$$\begin{matrix} [ Equation 2 ] & \\ ρ = \frac{{\sum }_{780}^{2500} ρ ( λ ) {E}_{λ} Δλ}{{\sum }_{780}^{2500} {E}_{λ} Δλ} & ( 2 )\end{matrix}$$

The determined near infrared transmittance τ and near infrared reflectance ρ were then used to find the near infrared ray absorption rate (α) from equation (3). Note that here, the units of α, τ and ρ are all %.

α=100−τ−ρ (3)

<Measurement of Visible Light Transmittance>

An ultraviolet-visible-near infrared spectrophotometer (U-4100, from Hitachi, Ltd.) was used to measure the visible light transmittance of the window film in accordance with the method for measuring visible light transmittance described in JIS A 5759:2016.

In addition, with regard to the countermeasures to condensation, the fabricated window film was evaluated by the following method. The results are shown in Table 1.

<Condensation Drying Evaluation>

The window film was affixed to reinforced glass with a size of 190 mm ×200 mm and a thickness of 4 mm, and then used in the evaluation. In addition, an incandescent light bulb (RF100V150WWD, from Panasonic Corporation) was used as a light source. The reinforced glass was separated by 130 mm from the lamp tip end with the surface on which the film was not affixed facing the lamp (light source) side, and was arranged so that the center of the glass matched the center of the lamp. At the surface of the reinforced glass at which the film was affixed, the temperature of the surface at a center part of the film was measured and recorded using a thermocouple (MF-0-K, from Toa Electric Inc.) and a multi-channel data logger (GL220, from Graphtec Corporation), and this temperature was used as the surface temperature of the window film.

In place of condensation water, 2.0 g of distilled water was uniformly sprayed onto a horizontally maintained window film using a spray bottle (150 ml spray bottle, from Daiso Industries Co., Ltd.). The weight of the distilled water was measured using an electronic balance (PB3002-S/FACT, from Mettler Toledo, Inc.). Next, a sample (reinforced glass on which the window film was affixed) was carefully positioned vertically upright and maintained in that state for 10 seconds to allow excess water to be removed by naturally flowing downward off the sample, after which the sample was installed in a prescribed arrangement, and the lamp was turned on. The time at which the lamp was turned on was recorded as the water evaporation start time. The time at which all of the water on the window film surface had evaporated based on observations by the naked eye was considered to be the time at which drying was completed, and the time from start until drying was completed was recorded as the drying time. In addition, the surface temperature of the window film when drying was completed was recorded as the temperature when dried.

<Visibility>

The sample that was used in the abovementioned condensation drying evaluation was used. In the visibility evaluation, water was sprayed onto the sample, the sample was installed at a prescribed position, and in the state right before the lamp was turned on, an object on the other side of the sample was viewed through the sample with the naked eye, and visibility was determined. The visibility of samples through which the object was clearly visible was determined to be “A”, and the visibility of samples through which it was difficult to see a clear image of the object due to water droplets on the surface was determined to be “B”.

### Example 2

A window film having the configuration of the window film 30 illustrated in FIG. 3 was fabricated. The same materials as those of Example 1 were used with the exception that the first adhesive layer 14 and the second substrate film 15 were omitted. More specifically, a laminated film (HF001, from Reiko Co., Ltd.) was used as the surface layer 31 and the substrate film 33, a 2 μm thick ultraviolet curable film layer formed from an ITO paint (PI-3Y, from Mitsubishi Materials Electronic Chemicals Co., Ltd.) and a carbon black dispersion (MHI Black #A980M, from Mikuni Color Ltd.) was used as the heat-generating layer 32, and a 24 μm thick acrylic resin pressure-sensitive adhesive (PMJ-1435, from 3M) was used as adhesive layer 34.

The fabricated window film was measured and evaluated with the same methods as those of Example 1. The results are shown in Table 1.

### Example 3

A window film having the configuration of the window film 50 illustrated in FIG. 5 was fabricated. More specifically, the same laminated film (HF001, from Reiko Co., Ltd.) as that of Example 1 was used as the surface layer 51 and the substrate film 53. In addition, a polyurethane resin (KL-540E, from Arakawa Chemical Industries, Ltd.) and an ATO dispersion (SNS-10M, from Ishihara Sangyo Kaisha, Ltd.) were mixed at a weight ratio of 100:22, and formed into a film with a dry thickness of 24 μm using a knife coater, and the layer obtained thereby was used as the heat-generating layer 56 having tacky adhesiveness.

The fabricated window film was measured and evaluated with the same methods as those of Example 1. The results are shown in Table 1.

### Comparative Example 1

The angle of contact with water on a glass window on which the window film was not affixed was measured. In addition, the condensation countermeasures were evaluated with the same methods as those of Example 1. The results are shown in Table 1.

### Comparative Example 2

A window film in which a surface layer, a substrate film, and an adhesive layer were laminated was fabricated. Note that the same materials as those of Example 1 were used with the exception that the heat-generating layer 12, the second substrate film 15, and the second adhesive layer 16 were omitted. More specifically, the same laminated film (HF001, from Reiko Co., Ltd.) as that of Example 1 was used as the surface layer and the substrate film, and a 20 μm thick acrylic resin pressure-sensitive adhesive (PMJ-1435, from 3M) was used as the adhesive layer. The fabricated window film was measured and evaluated with the same methods as those of Example 1. The results are shown in Table 1.

### Comparative Example 3

A window film in which a heat-generating layer, a substrate film, and an adhesive layer were laminated was fabricated. Note that the same materials as those of Example 1 were used with the exception that the surface layer 11, the first substrate film 13, and the first adhesive layer 14 were omitted. More specifically, as the heat-generating layer, a film was formed with a dried thickness of 2 μm through a gravure coating method using a mixed solution obtained by mixing an ITO paint (PI-3Y, from Mitsubishi Materials Electronic Chemicals Co., Ltd.) and a carbon black dispersion (MHI Black #A980M, from Mikuni Color Ltd.) at a weight ratio of 100:2, the film was then cured through ultraviolet irradiation with a cumulative irradiation dose of 108 mJ/cm² to form a layer, and this layer was used. In addition, a 5 μm thick polyester film (CM875, from 3M) was used as the substrate film, and a 4 μm thick acrylic resin pressure-sensitive adhesive (PMJ-1435, from 3M) was used as the adhesive layer. The fabricated window film was measured and evaluated with the same methods as those of Example 1. The results are shown in Table 1.

TABLE 1

| | Angle of | Near Infrared | Visible Light | | | Temperature |
|---|---|---|---|---|---|---|
| | Contact with | Ray Absorption | Transmittance | | Drying Time | when Dry |
| | Water (°) | Rate (%) | (%) | Visibility | (minutes:seconds) | (° C.) |
| Example 1 | 10 | 37 | 68 | A | 4:00 | 80.0 |
| Example 2 | 6 | 55 | 81 | A | 4:26 | 75.3 |
| Example 3 | 10 | 46 | 73 | A | 3:59 | 68.4 |
| Comparative | 45 | — | — | C | 15:25 | 58.2 |
| Example 1 | | | | | | |
| Comparative | 9 | 0 | 88 | A | 5:32 | 51.8 |
| Example 2 | | | | | | |
| Comparative | 69 | 37 | 68 | C | 8:28 | 103.2 |
| Example 3 | | | | | | |

### REFERENCE NUMERALS

10, 20, 30, 40, 50, 60: window film; 11, 21, 31, 41, 51: surface layer; 12, 22, 32, 45, 56, 67: heat-generating layer; 13: first substrate film; 14: first adhesive layer; 15: second substrate film; 16: second adhesive layer; 23, 33, 53, 63: substrate film; 24, 34, 44, 64: adhesive layer.

1. A window film comprising:
a hydrophilic outermost surface; and
a heat-generating layer which contains a near infrared ray absorbing material, absorbs near infrared rays, and generates heat.

2. The window film according to claim 1, wherein the outermost surface is hydrophilic at an angle of contact with water of 20° or less.

3. The window film according to claim 1, comprising:
a surface layer having the outermost surface; and
the heat-generating layer laminated on a surface side of the surface layer opposite the outermost surface.

4. The window film according to claim 1, wherein the outermost surface has a hydrophilic functional group.

5. The window film according to claim 1, comprising an adhesion surface on a surface of a side opposite the outermost surface.

6. The window film according to claim 5, comprising an adhesive layer having the adhesion surface.

7. The window film according to claim 5, wherein the heat-generating layer further comprises an adhesive, and the heat-generating layer has the adhesion surface.

8. The window film according to claim 1, wherein the heat-generating layer has an absorption rate of 30% or higher in a near infrared range of wavelengths from 780 nm to 2500 nm.

9. The window film according to claim 1, wherein the near infrared ray absorbing material contains a metal oxide.

10. The window film according to claim 1, wherein a visible light transmittance is 60% or higher.
